(19) United States
(12) Patent Application Publication
(10) Pub. No.: US 2026/0346414 A1
(43) Pub. Date: Nov. 5, 2026

(54) BICYCLE MULTI-TOOL STORABLE WITHIN STEERER TUBE

(71) Applicant: Sam YOUNG, Boise, ID (US)

(72) Inventor: Sam YOUNG, Boise, ID (US)

(21) Appl. No.: 19/661,562

(22) Filed: Apr. 28, 2026

Related U.S. Application Data
(60) Provisional application No. 63/798,756, filed on May 2, 2025.

(51) Int. Cl. B25B 27/00; B25G 1/08

(52) U.S. Cl. CPC B25B 27/0071; B25G 1/085

(57) ABSTRACT

A multi-tool storable within the hollow interior of a steerer tube of a bicycle has a main housing with a top end and a bottom end, and channels storing hex bits are formed therebetween. A socket, complementary to the stored hex bits, extends from the top end of the main housing. A chain breaker and an insert are engaged to the bottom end and a chain breaker screw extends through the chain breaker and insert. An external lock engages with the insert and provides an interface to store the multi-tool within the hollow interior.

### RELATED APPLICATIONS

This application claims priority to U.S. Provisional Application No. 63/798,756, filed May 2, 2025, the contents of which are fully incorporated herein by reference.

### BACKGROUND OF THE INVENTION

### Field of the Invention

The present invention relates generally to a bicycle tool, and more specifically, to bicycle tools that can be stored within a bicycle frame.

### Description of Related Art

Bicycles have been around for over 200 years and have advanced from early simple wooden frames with two wheels that utilized human propulsion to complex mechanical devices having numerous gears connected to a pedal system for propulsion. The pedal system was initially introduced in the 1860s and utilized cranks and pedals that were attached directly to the front wheel. Speed on these early pedal bicycles was limited due to the direct connection to the front wheel, i.e., one rotation of the pedal caused one rotation of the wheel. To increase speed on these early bicycle designs, the diameter of the front wheel was increased, which had the downside of making the rider unstable due to differing front and rear wheel sizes. By the late 1870s, the modern bicycle design was introduced. The early modern bicycles used equal sized front and rear wheels along with a pedal system that was connected to the rear wheel by a crankset and chain.

Today, modern bicycles are complex mechanical devices that have numerous mechanical systems working together to provide the rider with comfort and safety. For instance, the gear and pedal system on modern bicycles typically includes a chainring mechanically coupled to the pedals. The chainring may include multiple sprockets of various diameters. A cassette is mechanically coupled to the rear wheel and may also include multiple sprockets of varying diameters. The cassette is coupled to the chainring via a chain. A front derailleur coupled to a shifter mounted on the handle bars can move the chain from one sprocket to the next on the chainring. Similarly, a rear derailleur coupled to a second shifter mounted on the handle bars can move the chain from one sprocket to the next on the cassette. A rider can shift the front and rear gears to change the pedaling efficiency when riding in different conditions, i.e., uphill versus flat or downhill.

In addition to the complex gear and pedal systems, modern bicycles typically have either mechanical, cable-actuated disc brakes or hydraulic brake systems. The cable-actuated disc brakes are simpler than the hydraulic brake systems but do not provide the rider the same level of control over braking power. The hydraulic brake system on modern bicycles has a lever that when pulled compresses fluid in a master cylinder forcing pistons in the caliper to push the brake pads against a rotor to slow the wheel.

Modern bicycles have additional mechanical systems that a rider can adjust to achieve their desired level of comfort and riding difficulty. Increased mechanical complexity, however, leads to a commensurate increase in possible modes of failure. This can be especially problematic if a failure occurs or a mechanical adjustment is required while the rider is out on a ride. To combat this problem, many riders carry various bicycle tools in backpacks, hip packs, or other containers that are strapped to the bicycle frame. Carrying an extra tool bag while riding can be inconvenient or uncomfortable to the rider by adding unnecessary weight or bulkiness to the ride.

What is needed is a more streamlined and efficient way to store bicycle tools on a bicycle.

### SUMMARY OF THE INVENTION

The present invention relates to a multi-tool designed for storage within a hollow portion of a modern bicycle frame. More specifically, the presently disclosed multi-tool is designed to be stored within the hollow interior of the steerer tube that is coupled to the top of the bicycle's front fork. The steerer tube typically connects the handlebars to the frame and allows the rider to steer the front wheel that is coupled between arms of the fork. The multi-tool according to the present invention includes numerous tools useful for repair and maintenance on modern bicycles.

One embodiment of the present invention provides a multi-tool storable within a steerer tube of a bicycle. The multi-tool includes a main housing having a top end, a bottom end and a longitudinal body extending between the top and bottom ends. A means for storing one or more tools is formed in the longitudinal body. A means for engaging one of the stored tools is formed on and extends from the top end of the main housing. A first tool is also couplable to the bottom end. A tool insert abuts the first tool and a second tool is removably engaged through the tool insert and the first tool. The multi-tool also includes an external lock that has a first means for engaging the tool insert and a second means for engaging the hollow interior of the steerer tube.

In some embodiments, the stored tool engagement means is formed by a swiveling hex bit holder that is coupled to the top end of the main housing. Preferably, the hex bit holder is designed to swivel, or rotate, substantially 180-degrees relative to the longitudinal body of the main housing. In some embodiments, the one or more stored tools include one or more hex bits. The hex bits are engaged to the tool storage means formed in the longitudinal body. In further embodiments, the tool storage means is formed by one or more channels defined in the longitudinal body of the main housing. Each channel is designed to receive at least one stored tool, e.g., at least one type of hex bit.

In some embodiments, the first tool is formed as a bicycle chain breaker tool. The second tool may be a bicycle chain breaker screw. In other embodiments, the chain breaker screw extends through the tool insert and the first tool and is coupled to the bottom end of the main housing. Thus, the chain breaker screw may removably secure the first tool and the tool insert to the bottom end of the main housing.

In further embodiments, the tool storage means may include one or more magnets embedded in the longitudinal body of the main housing. The magnets may magnetically secure various types of hex bits along the longitudinal body. Alternatively, the core of the longitudinal body may be magnetic and one or more storage channels may be formed in the main housing along the longitudinal body.

Preferably the external lock forms a hollow channel. The tool insert may include external threads such that the first engagement means of the external lock is a threaded engagement between internal threads formed in the hollow channel and the external threads of the tool insert. In additional embodiments, the outer surface of the external lock is smooth such that the second engagement means is formed as a friction fit or press fit of the external lock within the hollow interior of the steerer tube. In other embodiments, the external lock may also include a means for removing the external lock from within the steerer tube. The removal means may be formed as a lip around the lower perimeter of the external lock, such that the lip is designed to be grasped by a user to pull the multi-tool from within the steerer tube.

In further embodiments, the second tool is designed to engage the tool engagement means at the top end of the main housing. Further, when the second tool is engaged to the tool engagement means, the second tool may be used in conjunction with the first tool; the first tool having been removed from the bottom end of the main housing for use as an independent tool.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a transparent perspective view of an embodiment of a multi-tool according to the present invention.

FIG. 2 is a partially exploded side view of the multi-tool of FIG. 1.

FIG. 3 is a partially exploded top view of the multi-tool of FIG. 1.

FIG. 4 is a bottom view of the multi-tool of FIG. 1.

FIG. 5 is an exploded perspective view of the multi-tool of FIG. 1.

FIG. 6 is a partially exploded cross-sectional side view, taken along line A-A of FIG. 2.

FIG. 7 is a side view of an alternative embodiment of an integrated tool engageable to a multi-tool according to the present invention.

FIG. 8 is a cross-sectional view of the integrated tool taken along line B-B of FIG. 7.

FIG. 9 is an exploded perspective view of an alternative embodiment of a multi-tool according to the present invention.

FIG. 10 is a partially transparent exploded perspective view of an embodiment of a multi-tool according to the present invention in use with a steerer tube of a bicycle fork.

FIG. 11 is a side view of the multi-tool and steerer tube of FIG. 10.

### DETAILED DESCRIPTION OF THE INVENTION

The following disclosure presents exemplary embodiments of multi-tool that may be integrated into the frame of a modern bicycle, or simply bike hereinafter. The disclosed multi-tool includes various types of common tools required for bike maintenance. The multi-tool is compact and can be customized by a rider to store tools specific to his bike to ensure compatibility between the stored tools and the mechanical systems of the bike.

In preferred embodiments, the multi-tool according to the present invention is stowable within a hollow portion of the bike frame. Exemplary embodiments disclosed herein illustrate the multi-tool as being stored within the steerer tube of a bike fork. The steerer tube is the portion that connects the fork to the bike frame and allows steering of the front wheel via the handlebars.

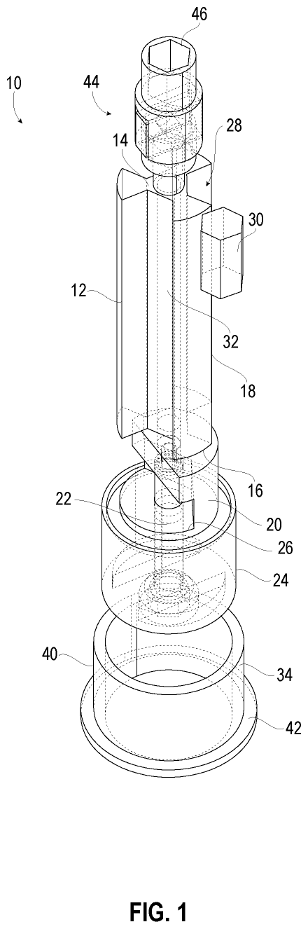

FIG. 1 is a partially transparent perspective view of an embodiment of a bike multi-tool according to the present invention. The multi-tool 10 has a main housing 12 with a top end 14 and a bottom end 16. The main housing 12 has a longitudinal body 18 extending between the top end 14 and the bottom end 16. A first tool 20 is removably engageable to the bottom end 16 of the main housing 12. In preferred embodiments, the first tool 20 may be a bicycle chain breaker tool. A second tool 22 is engaged through the first tool 20 and coupled to the bottom end 16 of the main housing 12. The second tool 22 is only partially shown in this view. In some embodiments, the second tool 22 may be a bicycle chain breaker screw that can be used with the first tool 20 to facilitate repair of a bike chain. A tool insert 24 abuts the lower end 26 of the first tool 20. Preferably, the second tool 22 extends through the tool insert 24 and the first tool 20 to couple with the bottom end 16 of the main housing 12, as will be detailed further below.

The main housing 12 also includes a means for storing one or more tools formed in the longitudinal body 18. In preferred embodiments, the storage means 28 is formed as one or channels 28 that extend between the top end 14 and the bottom end 16. The channels 28 are sized and shaped to receive one or more stored tools 30, such as the hexagonal bit. Other types of small bits may be used as the stored tools 30 in alternative embodiments. In some embodiments, the stored tools 30 are frictionally fit within a channel 28 and are secured due to the complementary profiles. In some more elaborate embodiments, the channels 28 may include a magnet 32 embedded within the inner surface of the channel 28. Alternatively, there may be a magnetic core 32 that the main housing 12 is molded around. In such embodiments, the channels 28 are formed within the longitudinal body 18 of the main housing 12 surrounding a magnetic core 32.

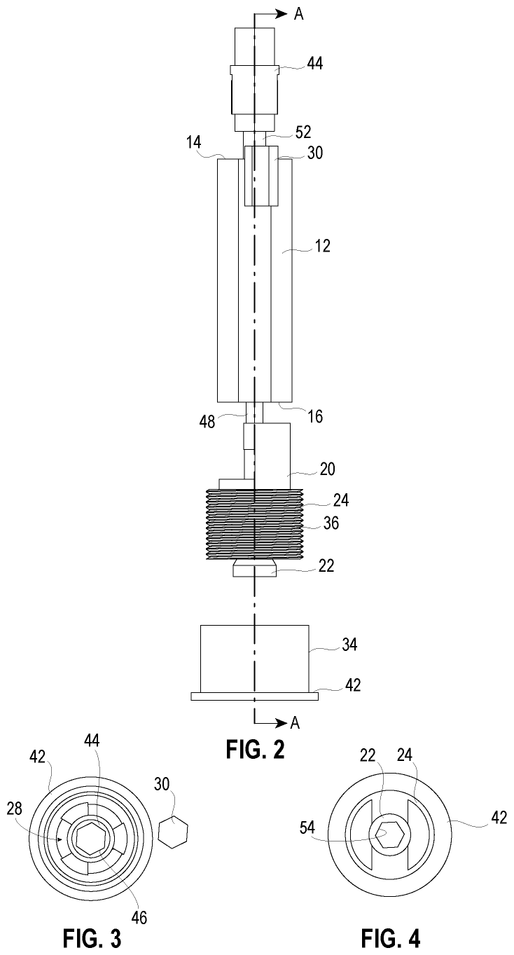

An external lock 34 has a first means for engaging the tool insert 24 and a second means for engaging the steerer tube of a bicycle fork. The external lock 34 is designed to removably secure the multi-tool 10 within the tube. The tool insert 24 may include male threads 36 formed around the outer surface thereof that are complementary to female threads 38 formed around the inner surface of the external lock 34. Note, the threads 36 and 38 are not shown in this FIG. 1 due to its partial transparency but can be seen in FIGS. 2 and 5-6. The second engagement means provided by the external lock 34 is preferably a friction fit between a smooth outer surface 40 of the external lock 34 and the hollow interior of a steerer tube. To facilitate removal of the external lock 34 from within the steerer tube, and thus removal of the multi-tool 10 from within the tube, a lip 42 is formed around the lower perimeter of the external lock 34. The lip 42 may be grasped by a rider to pull the multi-tool 10 from within hollow steerer tube.

As will be detailed further below, the second tool 22 extends through the tool insert 24 and is coupled to the bottom end 16 of the main housing 12. The second tool 22 secures the tool insert 24 against the bottom end 26 of the first tool 20, which is coupled to the bottom end 16 of the main housing 12. The external lock 34 threadably engages the tool insert 34 such that the multi-tool 10, as an assembly, can be stored within a hollow steerer tube. The threaded engagement between the tool insert 24 and the external lock 34 ensures the multi-tool 10 can be pulled out from within the steerer tube as a single unit by grasping and pulling the lip 42.

The top end 14 of the main housing 12 includes a means for engaging a tool, such as the stored tool 30. Preferably, the tool engagement means 44 at the top end 14 is a hex bit holder 44. The hex bit holder 44 is detailed further below but, generally, includes an open channel or socket 46 designed to receive the stored tool 30, e.g., having a profile complementary to the stored tool 30.

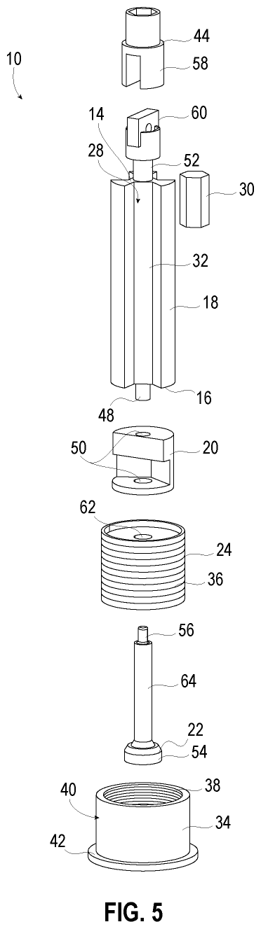

FIG. 2 is a partially exploded side view of an embodiment of the multi-tool according to the present invention. Extending from the bottom end 16 is a stud 48 that can engage with the first tool 20, or the second tool 22, to removably couple the first tool 20 and the tool insert 24, with the second tool 22 extending therethrough, to the bottom end 16. In some embodiments, the stud 48 is couplable within a channel 50 formed through the first tool 20. In some embodiments, the stud 48 has male threads that are complementary to female threads formed within the channel 50 of the first tool 20. Alternatively, the stud 48 may be friction fit within the channel 50 formed in the first tool 20. The second tool 22 includes a pin 56 formed at its upper end (see FIG. 5). In some embodiments, the second tool 22 is similarly frictionally engaged within the channel 50, opposite the stud 48, as will be discussed further below.

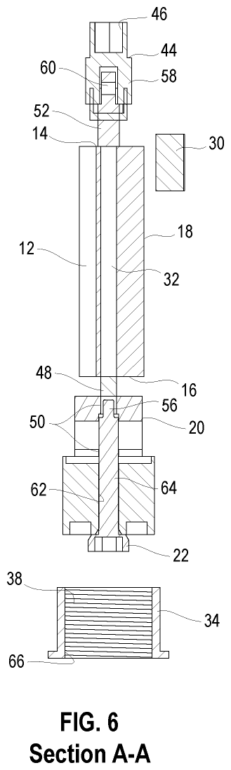

In some further alternative embodiments, the pin 56 may engage the stud 48 coupling the second tool 22 to the bottom end 16 through the tool insert 24 and the first tool 20. The second tool 22 extends fully through the tool insert 24 and the first tool 20 to allow the pin 56 to engage the stud 48. In some embodiments, the pin 56 may include threads that are complementary to threads formed within the stud 48. Alternatively, the pin 56 may be friction fit within a hollow interior of the stud 48. The second tool 22 is additionally secured in position by friction within the tool insert 24 and the first tool 20 with which the second tool 22 extends through. This is shown in more detail in FIG. 6 and discussed further below.

Similarly, extending from the top end 14 is a stud 52 with which the hex bit holder 44 is swiveling mounted too. This feature is discussed in more detail below with regard to FIGS. 5-6.

FIG. 3 is top view and FIG. 4 is a bottom view of the multi-tool according to the present invention. Preferably, there are at least three channels 28 formed in the main housing 12 and extending between the top end 14 and the bottom end 16. The channels 28 may be formed every 120 degrees around the main housing 12 and used to store a variety of different stored tools 30, such as a flat head hex bit, a Phillips head hex bit, and other common hex bits that may be necessary for repair or maintenance on a modern bike. Note, the stored tool 30 illustrated is meant as a generic representation of the various types of known hex bits. The open channel 46 is preferably a female hex socket 46 that is complementary to the stored hex bits 30. This allows a rider the convenience of storing various driver heads among the stored tools 30 that can be easily engaged to the socket 46. The longitudinal body 18 of the main housing 12 serves as a handle so that the rider can drive whichever stored tool 30 is engaged to the socket 46 to make quick repairs while out on a ride. The socket 46 and the stored tool 30 must be complementary to one another to facilitate compatibility therebetween. In alternative embodiments, a different socket 46 profile may be used in conjunction with a different stored tool 30 but in most preferred embodiments, the stored tools 30 are various types of hex bits and the socket 46 is a female hex socket, as these types of tools are relatively well known and available to riders. A rider can select the specific type of hex bits necessary for maintenance on their bike to be used as the stored tools 30.

The second tool 22 also includes a secondary socket head 54 formed in its lower end (FIG. 4). The secondary socket head 54 allows a rider to couple the second tool 22 to the bit holder 44 using one of the stored tools 30 as an intermediary coupling device. This connection again turns the longitudinal body 18 of the main housing 12 into a handle with which a rider may drive the second tool 22 when needed.

FIG. 5 is an exploded perspective view of an embodiment of the multi-tool 10. The bit holder 44 is formed with a yoke, or U-shaped extension, 58 that mounts on a shoulder 60 formed by the stud 52 extending from the top end 14. A pin extends through the yoke 58 and the shoulder 60 to couple the bit holder 44 thereto. The bit holder 44 may swivel, or rotate, on the axis provided by the pin. In some preferred embodiments, the bit holder 44 may swivel substantially 180 degrees on the pin so that the socket 46 may be pointed substantially perpendicular to the longitudinal body 18 in a forward and rearward direction. This provides a rider using the multi-tool 10 some flexibility in making repairs or maintenance on their bike.

At the other end, the channel 50 is formed through the first tool 20 and aligns with a second channel 62 formed through the tool insert 24. The stud 48 may engage the channel 50 formed through the top end of the first tool 20 to couple the first tool 20 to the bottom end 16 of the main housing 12. When assembled for storage, the second tool 22 extends through the channels 50 and 62. More specifically, the second tool 22 preferably includes a longitudinal body 64 extending between the pin 56 and the secondary socket head 54 formed opposite the pin. The longitudinal body 64 has an outer diameter slightly less than the inner diameter of the channels 50 and 62 to provide for a frictional engagement therebetween when the second tool 22 is stored through the tool insert 24 and the first tool 20. The external lock 34 may be threadably engaged with the tool insert 24 after the second tool 22 has been stored therethrough.

FIG. 6 is a partially exploded cross-sectional side view, taken along line A-A marked in FIG. 2, of an embodiment of the multi-tool according to the present invention. The longitudinal body 64 of the second tool 22 extends through the channels 50 and 62 of the first tool 20 and tool insert 24, respectively. In some embodiments, the frictional engagement between the longitudinal body 64 within the channels 50 and 62 is sufficient to secure the second tool 22. In some embodiments, the pin 56 at the upper end of the second tool 22 may be coupled to the stud 48 extending from the bottom end 16 of the main housing 12 to secure the tool insert 24 and the first tool 20 to the main housing 12. The stud 48 may also be frictionally fit within the channel 50 at the upper end of the first tool 20 and the pin 56 press-fit to an opening formed within the stud 48.

In some further alternative embodiments, the stud 48 may be frictionally or threadably engaged within the channel 50. In such an embodiment, the first tool 20 may be coupled to the stud 48 extending from the bottom end 16 of the main housing 12. The second tool 22 is secured by friction within channels 50 and 62, securing the tool insert 24 to the first tool 20 for storage.

In some embodiments, the external lock 34 is open at both the top and bottom ends to form an open-ended channel therethrough. Threads 38 are formed around the inner surface to threadably couple the external lock 34 with the tool insert 24 to assemble the multi-tool 10 for storage within a hollow steerer tube. In alternative embodiments, the external lock 34 may be closed at is lower end 66 to further secure the assemblage of the first tool 20, second tool 22, and tool insert 24 engaged with the main housing 12 for storage within the steerer tube.

In some embodiments, the main housing 12 may be separate from and attached to a magnetic core 32. For example, the core 32 may be a magnetized piece of machined metal and the main housing 12 may be molded or 3-D printed directly to the core. The channels 28 are formed by the main housing 12 surrounding the core 32 such that the stored tool 30 is magnetically secured within the channels 28.

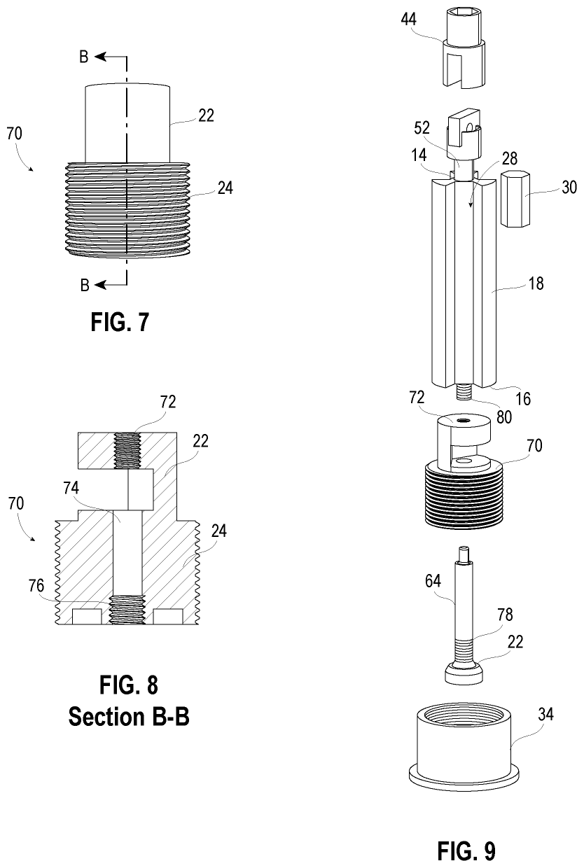

FIG. 7 is a side view of an alternative embodiment of a first tool usable with embodiments of the multi-tool according to the present invention. FIG. 8 is a cross-sectional view, taken along line B-B marked in FIG. 7, of the alternative first tool. In some alternative embodiments, the first tool and tool insert may be integrated into a first tool insert 70 that includes a first tool 22 integrated with a tool insert 24 as a single unit. The first tool 20 forms the upper part of the first tool insert 70 while the tool insert 24 forms the lower portion thereof. In such an embodiment, the first tool 22 includes a threaded aperture 72 formed through the upper end thereof and aligned with a channel 74 formed through the tool insert 24 portion. The lower end of the channel 74 is internally threaded 76 and configured to engage threads 78 formed around the longitudinal body 64 of an embodiment of the second tool 22 (see FIG. 9). The first tool insert 70 is designed to couple directly to the bottom end 16 of the main housing 12 and threadably receive the second tool 22 in the channel 74. This provides a more reliable connection between the main housing 12 and the tools 70, 22. The insert portion 34 remains externally threaded 36, as described above, to engage the external lock 34.

FIG. 9 is an exploded perspective view of an alternative embodiment of the multi-tool. The main housing 12 is substantially similar to as described above and thus includes one or more channel 28 formed in the longitudinal body 18 designed for storing one or more tools 30, such as various types of hex bits. A hex bit holder 44 extends from the upper end 14 of the main housing 12 and is mounted on the stud 52 as described above. Extending from the bottom end 16 of the main housing 12 is a threaded stud 80 designed to threadably engage the threaded aperture 72 formed in the first tool insert 70. The second tool 22 is modified when compared to that described above to include threads 78 formed around the longitudinal body 64. The threads 78 threadably engage with the threaded portion 76 of the channel 74. The external lock 34 engages the external threads 36 formed around the insert portion 24 of the first tool insert 70 to provide the interface for storage within the steerer tube, as described further below.

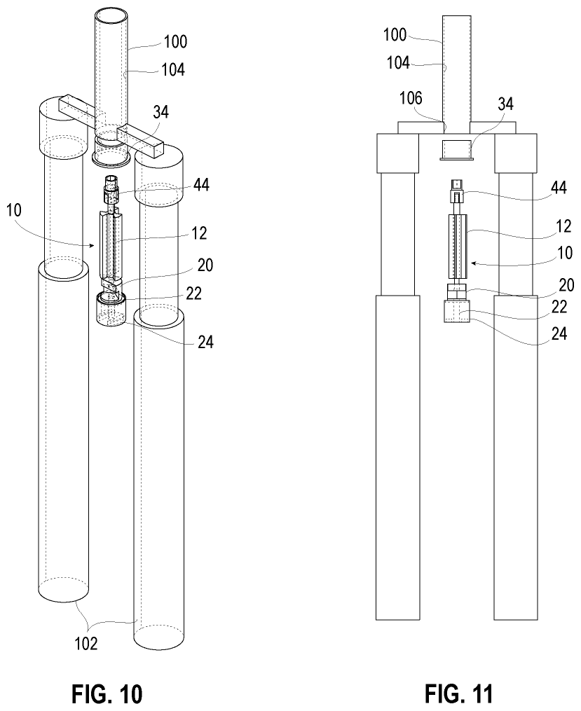

FIG. 10 is a partially transparent perspective view of an embodiment of a multi-tool prior to storage within a steerer tube of a bike. FIG. 11 is a partially transparent front view of FIG. 10. As briefly mentioned above, a steerer tube 100 typically connects a bike's fork 102 to the handlebars to allow a rider to steer the front wheel. The front wheel of the bike would be mounted between the fork arms 102. In many modern bikes, the front wheel is mounted between the fork arms 102 using what is known as a thru-axle or a quick release system. In either case, the front wheel can be readily removed without requiring any tools. Upon removal of the front wheel from the bike, the bottom portion of the steerer tube 100 may be accessed.

The steerer tube 100 has a hollow interior 104 that can be accessed from an opening 106 formed at the bottom end, opposite from where the handlebars are attached. Storage of the multi-tool 10 within the hollow interior 104 of the steerer tube 100 may be accomplished in several different ways. In any of the following storage methods, it should be assumed that the second tool 22 is already secured within through the first tool 20 and tool insert 24 and the assembly has been coupled to the main housing 12. The external lock 34 may be threaded onto the tool insert 24 prior to storage within the interior 104. After threading the lock 34 onto the insert 24, a rider simply presses the multi-tool into the hollow interior 104. The external lock 34 frictionally engages the inner surface of the hollow interior 104 to secure the multi-tool 10 therein.

Alternatively, the external lock 34 may be pre-positioned within the hollow interior 104 at the opening 106. The remainder of the multi-tool 10 may thereafter be pressed upward through the pre-positioned external lock 34 into the hollow interior 104 until reaching the tool insert 24. A rider may simply rotate the multi-tool 10 to cause the threads 36 to engage with threads 38 thereby securing the multi-tool 10 within the interior 104.

The storage methods described above apply equally to the embodiment of the multi-tool shown in FIG. 9 utilizing the first tool insert 70 rather than a separate the first tool 20 and tool insert 24. The second tool 22 with its threaded portion 78 is engaged within the first tool insert 70 and the first tool insert 70 is engaged to the threaded stud 80 prior to storage within the steerer tube 100.

Once the multi-tool 10 is stored within the steerer tube 100, a rider can remount the front wheel to the fork 102 to continue riding the bike. As stated above, many modern bikes do not require tools to demount the front wheel so storage of the multi-tool 10 within a portion of a bike not accessible when the front wheel is attached does not limit the tool's usefulness. A rider is able to safely and securely store the multi-tool 10 in a portion of the bike that is otherwise not used while maintaining ready access to the tool in the event a need arises while on a ride. The multi-tool 10 can be equipped with various bits 30 specific to the rider's bike to ensure the multi-tool 10 is useful when needed. Further, the first tool 20 combined within the second tool 22, e.g., a chain breaker and chain breaker screw, allows a rider to carry with them the tools necessary to make otherwise difficult repairs while out on a ride.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A multi-tool storable within a steerer tube of a bicycle, comprising:
a main housing having a top end, a bottom end, and a longitudinal body extending between the top end and the bottom end;
a first tool removably couplable to the bottom end;
a tool insert abutting the first tool;
a second tool removably engaged through the tool insert and the first tool;
an external lock having a first means for engaging the tool insert and a second means for engaging a hollow interior of the steerer tube of the bicycle;
a means for storing one or more tools formed in the longitudinal body; and
a means for removably engaging one of the stored tools formed at and extending from the top end.

2. The multi-tool of claim 1, wherein the tool engagement means comprises a swiveling hex bit holder.

3. The multi-tool of claim 2, wherein the swiveling hex bit holder is configured to swivel substantially 180-degrees relative to the longitudinal body.

4. The multi-tool of claim 1, wherein the first tool and the tool insert are formed together as a first tool insert removably couplable to the bottom end of the main housing.

5. The multi-tool of claim 1, wherein the tool storage means comprises one or more channels formed in the longitudinal body, each channel configured to receive a tool.

6. The multi-tool of claim 5, wherein the channels are configured to receive one or more hex bits.

7. The multi-tool of claim 1, wherein the first tool comprises a bicycle chain breaker tool.

8. The multi-tool of claim 1, wherein the second tool comprises a bicycle chain breaker screw.

9. The multi-tool of claim 8, wherein the bicycle chain breaker screw extends through the tool insert and the first tool and is coupled to the bottom end of the main housing.

10. The multi-tool of claim 9, wherein the bicycle chain breaker screw removably secures the first tool to the bottom end and the tool insert to the first tool.

11. The multi-tool of claim 1, further comprising a magnetic core forming the longitudinal body and wherein the main housing surrounds the magnetic core.

12. The multi-tool of claim 1, wherein the external lock comprises a hollow channel.

13. The multi-tool of claim 12, wherein the tool insert comprises external threads formed around an outer surface of the tool insert.

14. The multi-tool of claim 13, wherein the first engagement means comprises internal threads formed around the hollow channel that are complimentary to the external threads of the tool insert.

15. The multi-tool of claim 1, wherein the external lock comprises a smooth outer surface.

16. The multi-tool of claim 15, wherein the second engagement means comprises a friction fit of the external lock within the hollow interior of the bicycle steerer tube.

17. The multi-tool of claim 16, wherein the external lock further comprises a means for removing the external lock from the steerer tube of the bicycle.

18. The multi-tool of claim 17, wherein the removal means comprises a lip formed around a lower end of the external lock, the lip configured for grasping to facilitate removal.

19. The multi-tool of claim 1, wherein the second tool is configured to engage the tool engagement means.

20. The multi-tool of claim 19, wherein the second tool, when engaged to the tool engagement means, is configured for engagement with the first tool.
